(19) United States
(12) Patent Application Publication
(10) Pub. No.: US 2026/0121699 A1
(43) Pub. Date: Apr. 30, 2026

(54) ENHANCED BEAMFORMING GRANULARITY

(71) Applicant: T-Mobile USA, Inc., Bellevue, WA (US)

(72) Inventors: Christopher Bailey, Overland Park, KS (US); Ryan Patrick Dreiling, Shawnee, KS (US)

(21) Appl. No.: 18/925,448

(22) Filed: Oct. 24, 2024

(51) Int. Cl. H04B 7/0426; H04B 7/06; H04L 5/00

(52) U.S. Cl. CPC H04B 7/0426; H04B 7/0632; H04B 7/06958; H04L 5/0048

(57) ABSTRACT

System and methods for providing antenna identifiers to base stations with reference signals for use in adjusting mobile device antenna configurations are described. A mobile device may transmit an antenna identifier with a reference signal value to a base station. The base station uses the reference signal value to determine an quality of the channel over which the reference signal value was received. If the quality of the channel is poor, the base station generates instructions that include the antenna identifier for the mobile device. These instructions may cause the mobile device to adjust the indicated antenna to improve the antenna's performance. The base stations sends these instructions to the mobile device for implementation, resulting in improved performance and throughput for the mobile device.

### BACKGROUND

Wireless communications technologies have improved significantly over recent years, resulting in the proliferation of wireless communications devices (e.g., user devices such as mobile telephones, smartphones, tablets, laptops, etc.). Among such improvements is the use of multiple antennas configured at an individual wireless communications device. Various techniques have also been developed to more effectively and efficiently use such multiple antennas (often referred to as an antenna array) for the transmission and reception of wireless signals, including beamforming and multiple-input and multiple-output (MIMO). Beamforming is a signal processing technique that may, among other features, introduce directivity to an antenna array. MIMO techniques facilitate the use of multiple antennas (and/or multiple transmissions and/or receptions) at a single wireless communications device and/or over a single radio channel. These and other techniques used with multiple antennas and/or multiple transmissions at a single wireless communications device have greatly increased the bandwidth available at such devices. However, it remains difficult for a network device, such as a base station, to determine which antennas configured at a wireless communications device are associated with particular signals. This may make it challenging for the base station to configure the wireless communications device for improved efficiency and throughput.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a schematic diagram of an illustrative wireless communication network environment in which systems and techniques for enhanced beamforming granularity may be implemented, in accordance with examples of the disclosure.

FIG. 2 is a flow diagram of an illustrative process for implementing enhanced beamforming granularity, in accordance with examples of the disclosure.

FIG. 3 is another flow diagram of an illustrative process for implementing enhanced beamforming granularity, in accordance with examples of the disclosure.

FIG. 4A is a diagram representing exemplary antenna signals that may be received at a base station before implementing enhanced beamforming granularity in accordance with examples of the disclosure.

FIG. 4B is a diagram representing exemplary antennas signals that may be received at a base station after implementing enhanced beamforming granularity, in accordance with examples of the disclosure.

FIG. 5 is a schematic diagram of a subframe that may be used to implement enhanced beamforming granularity, in accordance with examples of the disclosure.

FIG. 6 is a schematic diagram of illustrative components in an example user device that is configured for enhanced beamforming granularity, in accordance with examples of the disclosure.

FIG. 7 is a schematic diagram of illustrative components in an example computing device that is configured for performing one or more aspects of enhanced beamforming granularity, in accordance with examples of the disclosure.

### DETAILED DESCRIPTION

### Overview

This disclosure is directed in part to systems and techniques for improving the performance of multiple antenna wireless communications systems in wireless communications networks and other networks that facilitate wireless communications between computing devices. Such networks include any networks that may facilitate wireless communications services for one or more wireless communications devices. Such networks include networks that support one or more 3GPP standards, including, but not limited to, Long Term Evolution (LTE) networks (e.g., 4G LTE networks), New Radio (NR) networks (e.g., 5G NR networks), and 6G networks. However, the disclosed systems and techniques may be applicable in any network or system in which a user device may request and receive access to communicate with one or more network and/or remote devices using any protocol.

In examples, the disclosed systems and techniques may enhance the granularity of beamforming configurations and processes to increase throughput and improve the efficiency of allocation of wireless communications system and device resources. In conventional systems, a wireless user device (e.g., mobile telephone, smartphone, user equipment (UE), etc.; generally referred to as “UE” herein) may wirelessly communicate with a base station (e.g., gNodeB, eNodeB, NodeB, base transceiver station (BTS), etc.) to exchange wireless communications and provide wireless communications services, such as voice, text, and data services. A modern wireless user device may be configured with multiple antennas that may be individually configurable and/or controllable to increase the bandwidth available to the device. These antennas may be controlled using various beamforming and MIMO techniques.

A wireless user device may transmit and receive wireless signals from each of the individual antennas that may be configured at the wireless user device. Typically, each antenna may transmit and/or receive signals at the same time as any other antenna, but using a different portion of the radio frequency band in which the wireless user device is configured to operate. A base station may likewise be configured to receive such signals contemporaneously. A base station may similarly be configured to transmit and receive wireless signals using the same portions of that radio frequency band. These signals may be organized into channels based on frequency and be organized into frames, subframes, slots, and symbols based on time.

A base station may determine various downlink channel characteristics for a wireless user device (e.g., characteristics of the current signal reception capabilities of the wireless user device) based on uplink channel transmissions received from the wireless user device. In examples, a wireless user device may transmit a reference signal on an uplink channel for use by a base station in determining downlink channel characteristics. An example of such a reference signal may be a sounding reference signal (SRS), for instance, as used in 4G LTE and 5G NR systems. A reference signal may be transmitted as a symbol in a slot (e.g., within a subframe of a frame) of an uplink channel.

A reference signal transmitted on an uplink channel by a wireless user device may allow a base station to antenna identifier and a reference signal. However, such reference signals do not indicate or readily allow the base station to determine the particular antenna configured at the wireless user device that transmitted the reference signal. Therefore, the base station may not be readily able to determine the particular receive antenna associated with the downlink channel characteristics. Because the individual antennas at a wireless user device may be controllable and/or configurable (e.g., based on instructions generated at the base station and transmitted to the wireless user device), this lack of such specific antenna information prevents more efficient configuration of antenna resources at the wireless user device, thereby inhibiting improved use of the available bandwidth. By implementing the disclosed systems and techniques to identify, to base station, particular antennas associated with reference signals, current antenna configurations may be more readily determined and antenna configuration adjustments may be more efficiently implemented, thereby increasing bandwidth utilization and improving the user experience.

In examples, a wireless user device may be configured to transmit, on an uplink channel, a symbol indicating the specific antenna configured at the wireless user device transmitting the symbol. This symbol may be referred to herein as an “antenna symbol.” The wireless user device may transmit an antenna symbol along with a reference signal symbol transmitted on the uplink channel. In examples, the wireless user device may transmit an antenna symbol temporally proximate to a reference signal symbol (e.g., immediately preceding or following the reference signal symbol). The wireless user device may be configured to transmit an antenna symbol with each reference signal symbol transmitted and/or transmit an antenna symbol periodically and/or based on various criteria.

In other examples, an indication of a specific antenna and a reference signal may be represented in a single symbol. For example, a portion of a symbol may be used to represent a reference signal, and another portion of the same symbol may be used to represent an antenna identifier. Alternatively or additionally, an antenna identifier and a reference signal may be used to generate (e.g., using one or more operations) a symbol representing both the antenna identifier and a reference signal. The specific value used to identify an antenna, regardless of representation means used in an uplink channel transmission, may be an antenna port value. Other means of representing and transmitting an indication of a specific wireless user device antenna may be used and are contemplated as within the scope of the instant disclosure.

A wireless user device may be configured to transmit antenna information for each antenna transmitting on an uplink channel, thereby providing a base station with specific antenna information for each antenna transmitting (and, presumably, capable of receiving) at the wireless user device. Using this antenna information, the base station may perform one or more operations to determine antenna configuration instructions that may be sent to the wireless user device. For example, the base station may perform downlink channel quality and/or characteristics determinations based on the reference signals received from the wireless user device. The base station may then determine, based on such quality and/or characteristics, whether any changes to the antenna configuration at the wireless user device are warranted. For instance, if configuration changes are warranted based on the quality and/or characteristics of a channel determined based on particular reference signals, the base station may determine the particular antennas associated with those reference signals and generate antenna configuration instructions for the wireless user device that include indications of those particular antennas. These instructions may be transmitted to the wireless user device for implementation.

For instance, the base station may determine that two of the four channels over which a wireless device is transmitting reference signals are of poor quality (e.g., low detected transmit power). The base station may use the antenna information included in the uplink channel data provided over the two low-quality channels to determine the specific antennas associated with those channels. The base station may then generate configuration instructions to change the antenna configuration at the wireless user device to address the detected channel quality issues. These instructions may then be transmitted to the wireless user device.

For example, the base station may generate instructions directing the wireless user device not to use the two antennas associated with the low-quality transmissions for receiving signals from the base station. These instructions may explicitly identify the antennas associated with the low-quality transmissions based on the antenna information received from the wireless user device on the channels that were determined to be of poor quality. The base station may also, or instead, determine not to transmit signals to the wireless user device on channels associated with those two antennas.

The base station may also, or instead, generate instructions directing the wireless user device to (e.g., only) use the two antennas that are not associated with the low-quality transmissions for receiving signals from the base station. These instructions may explicitly identify the antennas associated with the higher quality transmissions based on the antenna information received from the wireless user device on the channels that were not determined to be of poor quality. The base station may also, or instead, determine to (e.g., only) transmit signals to the wireless user device on channels associated with the two antennas that are not associated with the low-quality transmissions.

By removing low-performing antennas from use for user data, the disclosed systems and techniques may save battery power at the wireless user device and increase throughput and bandwidth utilization by avoiding retransmissions and high error rates likely to be experienced using low-quality channels and the associated antennas.

Alternatively or additionally, the base station may generate instructions directing the wireless user device to adjust the configuration of antennas associated with low-quality transmissions. For example, the base station may generate instructions directing the wireless user device to increase power at the two antennas that are associated with the low-quality transmissions to improve the ability of those antennas to receive signals from the base station. These instructions may explicitly identify the antennas associated with the low-quality transmissions based on the antenna information received from the wireless user device on the channels that were determined to be of poor quality. Alternatively or additionally, the base station may generate instructions directing the wireless user device to adjust one or more other configurations to improve the reception capabilities of such antennas, such as adjusting the directionality of the specific antennas (e.g., using beamforming techniques). Any such instructions may include information identifying the antennas associated with the configuration changes. Any other wireless user device instructions and/or adjustments may be determined and or used based on the antenna identification and related operations disclosed herein.

By identifying particular antennas associated with uplink channel transmissions that can be used to determine downlink channel quality and characteristics, systems and methods described herein can improve the performance and increase the efficiency of wireless user devices and network resources while improving the user experience by mitigating the effects of poor quality channels and associated antennas. For example, the methods and systems described herein may be more efficient and/or more robust than conventional techniques, as they may increase the efficiency of wireless user device and network resource utilization by reducing unnecessary signaling on the network and power usage by the wireless user device by reducing the need for retransmissions and other operations responsive to low quality channel conditions. That is, the methods and systems described herein provide a technological improvement over existing systems and processes by facilitating an improved user experience and increasing device and network efficiency, reducing the use of wireless user device and common resources to work around poor antenna performance. In addition to improving the efficiency of network and device resource utilization, the systems and methods described herein can provide more robust systems by, for example, making more efficient use of network devices and user devices by reducing unnecessary and/or unproductive device and network interactions (e.g., retransmissions), thereby freeing network and user device resources for more productive operations.

Illustrative environments, processes, and techniques for implementing systems and methods for enhancing beamforming granularity are described below. However, the described systems and techniques may be implemented in other environments.

### Illustrative System Architecture

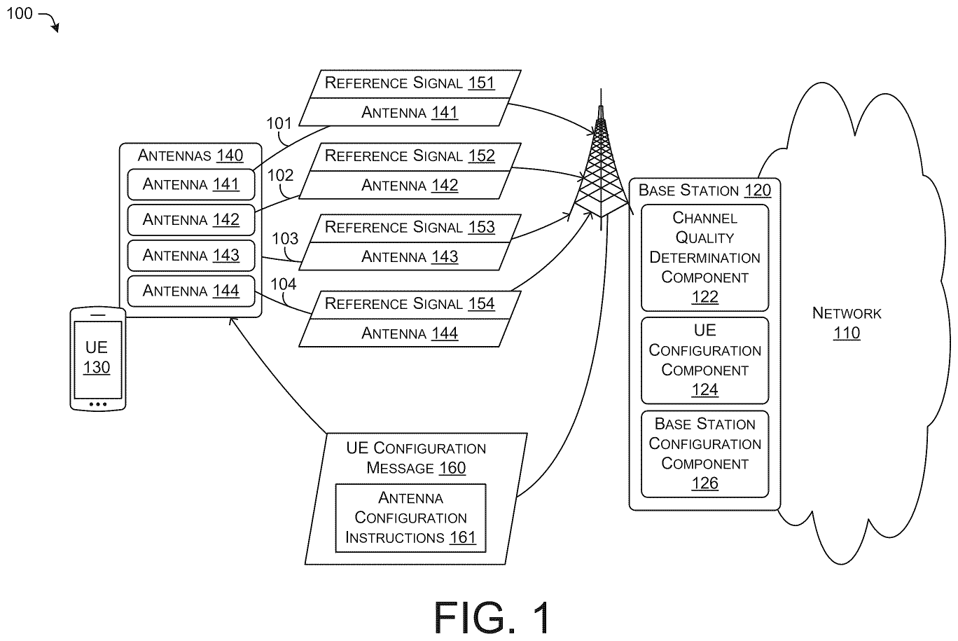

FIG. 1 is a schematic diagram of an illustrative wireless network environment 100 in which the disclosed systems and techniques may be implemented. The environment 100 may include a base station 120 that may be any type of base station, including, but not limited to, a BTS, a NodeB, an eNodeB, a gNodeB, etc. The base station 120 may communicate with other components and functions in a network 110. The network 110 may be a wireless communications network that may facilitate communication between computing devices and/or mobile devices (e.g., UEs such as UE 130). The network 110 may be any type of wireless communications network and may include any number and type of core and edge network components. Various connections between components and functions in the network 110 may be wired, wireless, or a combination thereof. Various connections between the network 110 and devices that communicate with the network 110 (e.g., via edge components such as base stations) may be wired, wireless, or a combination thereof. The components and functions described herein may be implemented as physical devices, as software components and/or functions executing on one or more computing devices, and as any combination thereof.

In various embodiments, the network 110 may facilitate the establishment of communications sessions for one or more wireless devices, such as a UE 130. In examples, the network 110 may facilitate (e.g., packet-based) communications between such wireless devices and other wireless devices, devices on the Internet, one or more systems and/or devices configured thereon, and/or one or more other (e.g., data, voice, etc.) networks.

In FIG. 1, connections between components may be logical and/or communications connections that may be facilitated by one or more wired and/or wireless connections and may include traversal of one or more devices, components, and/or functions that may or may not be shown in FIG. 1.

The UE 130 may be operating in the general vicinity of the base station 120. The UE 130 may be any type of wireless device capable of wirelessly interacting with the base station 120 (e.g., a smartphone, a cellular telephone, etc.). The UE 130 may be configured with an array of antennas 140 that may include antennas 141, 142, 143, and 144. The UE 130 may be configured to use various beamforming and/or MIMO techniques and technologies to transmit and receive signals using the antennas 140.

For example, the UE 130 may be configured to operate using a particular band of frequencies. Accordingly, the UE 130 may assign a distinct sub-band of this band of frequencies to each individual antenna 141, 142, 143, and 144. Each such sub-band may represent a distinct channel. Each antenna 141, 142, 143, and 144 may transmit and/or receive signals on its assigned channel at the same time as any other antenna transmits and/or receives signals on its respective channel. The base station 120 may be configured to receive such signals contemporaneously. These channels may be temporally organized into frames, subframes, slots, and symbols based on time.

In examples, the UE 130 may be configured to operate the antennas 140 to transmit, among other signals, reference signals (e.g., SRSs in uplink control information (UCI)). For example, as shown here, the antenna 141 may be operated by the UE 130 to transmit a reference signal 151 on a channel 101 to the base station 120. Likewise, the antenna 142 may be operated by the UE 130 to transmit a reference signal 152 on a channel 102 to the base station 120, the antenna 143 may be operated by the UE 130 to transmit a reference signal 153 on a channel 103 to the base station 120, and the antenna 144 may be operated by the UE 130 to transmit a reference signal 154 on a channel 104 to the base station 120.

The UE 130 may further operate the antennas 140 to also transmit, among other signals, antenna identification information (e.g., in UCI with an SRS). For example, as shown here, the antenna 141 may be operated by the UE 130 to transmit an indication of the antenna 141 (e.g., an antenna 141 identifier or symbol) along with (e.g., temporally proximate to) the reference signal 151 on the channel 101 to the base station 120. Likewise, the antenna 142 may be operated by the UE 130 to transmit an indication of the antenna 142 (e.g., an antenna 142 identifier or symbol) along with (e.g., temporally proximate to) the reference signal 152 on the channel 102 to the base station 120, the antenna 143 may be operated by the UE 130 to transmit an indication of the antenna 143 (e.g., an antenna 143 identifier or symbol) along with (e.g., temporally proximate to) the reference signal 153 on the channel 103 to the base station 120, and the antenna 144 may be operated by the UE 130 to transmit an indication of the antenna 144 (e.g., an antenna 144 identifier or symbol) along with (e.g., temporally proximate to) the reference signal 154 on the channel 104 to the base station 120.

The base station 120 may be configured with various components that may perform channel quality determination and UE and base station configuration operations. For example, the base station 120 may be configured with a channel quality determination component 122 that may determine channel quality and/or characteristics for individual channels. For example, the channel quality determination component 122 may determine a channel quality for each of the channels 101, 102, 103, and 104 based on the corresponding received reference signals 151, 152, 153, and 154. The channel quality determination component 122 may provide this information to a UE configuration component 124. The channel quality determination component 122 may also provide antenna identifying information received with the reference signals 151, 152, 153, and 154 (e.g., identifiers for antennas 141, 142, 143, and 144) to the UE configuration component 124 with the channel quality information.

The UE configuration component 124 may determine, based on individual channel quality determinations, whether and how to instruct the UE 130 to configure its antennas. For example, if the channel quality is determined to be poor for channels 102 and 103 based on the respective reference signals 152 and 153, the UE configuration component 124 may determine the antenna 142 and 143 identifiers that are associated with those channels (e.g., from the information provided by the channel quality determination component 122 and/or from the signals received over the channels 102 and 103). The UE configuration component 124 may generate one or more instructions for the UE 130 that may control or configure the antennas 140 in some manner. These instructions may specify the particular antennas to be controlled or configured.

For example, the UE configuration component 124 may generate instructions that will cause the UE 130 to cease using the antennas 142 and 143 (e.g., do not process signals received from base station 120 on antennas 142 and 143, do not process user data received via signals received from base station 120 on antennas 142 and 143, etc.). In another example, the UE configuration component 124 may generate instructions that will cause the UE 130 to alter the operation of the antennas 142 and 143 (e.g., increase power on the antennas 142 and 143, increase power by 50% on the antennas 142 and 143, adjust directionality of the antennas 142 and 143 and/or any of the antennas, etc.).

These instructions may be combined into or otherwise generated as antenna configuration instructions 161. The antenna configuration instructions 161 may be transmitted to the UE 130 within or as a UE configuration message 160 (using any effective channel or other means of communication with the UE 130). The UE 130 may implement the antenna configuration instructions 161 upon receipt and begin operating the antennas 140 based on the new configurations.

Alternatively or additionally, the base station 120 may modify its own configuration based on the determine channel qualities and/or characteristics. For example, the base station 120 may be configured with a base station configuration component 126 that may receive the determined channel quality for each of the channels 101, 102, 103, and 104 from the channel quality determination component 122, in examples, along with antenna identification information for the corresponding antennas 141, 142, 143, and 144. The base station configuration component 126 may determine, based on received information indicating that the channel quality for channels 102 and 103 is poor, to transmit signals (e.g., any signals and/or user data signals) to the wireless user device on (e.g., only) channels 101 and 104 (e.g., only using the channels associated with the antennas 141 and 144). For example, the base station may determine to (e.g., only) use the one or more of its antennas and/or antenna ports that are associated with (e.g., configured to transmit signals to and/or receive signals from) the particular UE antennas determined to have sufficient channel quality.

The base station 120 may reevaluate channel quality based on the reference signals received over the channels 101, 102, 103, and 104 in response to each received reference signal. Alternatively or additionally, the base station 120 may be configured to periodically reevaluate channel quality and/or reevaluate channel quality in response to one or more conditions or triggers. In examples, the base station 120 may be configured to perform this channel quality evaluation and antenna configuration operations when initially establishing communications with the UE 130 (e.g., when the UE 130 first enters a cell serviced by the base station 120).

By individually identifying antennas of the UE 130 associated with channels and making appropriate configuration adjustments based on associated channel quality determinations, the base station 120 may assist the UE 130 in making more efficient use of power and network resources than if the UE 130 attempted to use poorly performing antennas in suboptimal configurations. For example, the UE 130 may avoid wasting resources on retransmissions and error handling if poorly performing antennas are not used or adjusted to have better performance according to the disclosed systems and techniques.

### Illustrative Operations

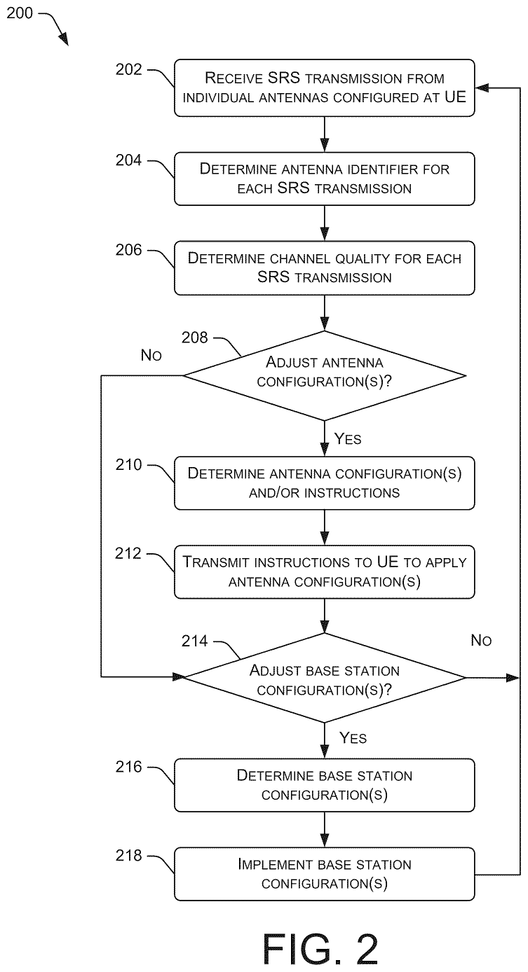

FIG. 2 shows a flow diagram of an illustrative process 200 for determining, at a base station, UE antenna configurations based on received reference signals and antenna identifiers according to the disclosed embodiments. The process 200 is illustrated as a collection of blocks in a logical flow diagram, which represents a sequence of operations that can be implemented in software and executed in hardware. In the context of software, the blocks represent computer-executable instructions that, when executed by one or more processors, perform the recited operations. Generally, computer-executable instructions include routines, programs, objects, components, data structures, and the like that perform functions and/or implement particular abstract data types. The order in which the operations are described is not intended to be construed as a limitation, and any number of the described blocks can be omitted and/or combined in any order and/or in parallel to implement the processes. For discussion purposes, the process 200 may be described with reference to the wireless network environment 100 of FIG. 1, however other environments may also be used.

At block 202, a base station (e.g., base station 120) may receive reference signal transmissions, such as SRSs, from individual antennas configured at a UE (e.g., UE 130). For example, each individual antenna at the UE may transmit (e.g., as part of UCI) an SRS symbol to the base station over a channel assigned to the antenna. Each individual antenna of the UE may also transmit an antenna symbol or other antenna identifier along with the SRS symbol, for example, as a proximate symbol and/or as a symbol that represents both the SRS and the antenna identifier. At 202, the base station may receive such transmissions.

At block 204, the base station may determine an antenna identifier for each SRS transmission received. For example, the base station may be configured to determine an antenna identifier from a symbol immediately temporally subsequent to an SRS symbol. This antenna identifier may take any suitable form, including data indicating an antenna port. The base station may store this data along with various other types of data, such as a UE identifier, channel identifier, SRS value, etc., for example, in a data structure that may be associated with the particular channel and UE combination.

At 206, the base station may perform a channel quality and/or characteristics determination for each channel based on the respective SRS. For example, the base station may determine any one or more of a variety of channel characteristics, including power, signal-to-noise ratio (SNR), etc.

Based on the channel quality characteristics determined for each channel, at 208, the base station may determine whether any antennas associated with such channels should be adjusted. For example, the base station may determine that a particular channel has a transmit power level that is below a minimum acceptable power level threshold. In response, at 208, the base station may determine that one or more operations are to be performed to adjust the antenna associated with that channel. The base station may determine that instructions are to be generated and sent to the UE adjusting this and/or any other antennas. Alternatively or additionally, the base station may, by default, generate instructions to configure antennas at the UE regardless of the results of the channel quality and/or characteristics determination operations at 206. Such instructions may include the antenna identifiers of the specific antennas to be configured as described herein.

If, at 208, the base station determines that no antenna adjustments are needed or that otherwise no instructions are to be generated and sent to the UE based on the channel quality and/or characteristics determination operations performed at 206, the process 200 may proceed to 218.

If, at 208, the base station determines that one or more antenna adjustments are needed and/or that instructions are to be generated and sent to the UE based on the channel quality and/or characteristics determination operations performed at 206, at 210, the base station may determine the particular antenna configurations that it will instruct the UE to implement. For example, the base station may determine (e.g., based on channel quality determinations) that one or more particular antennas at the UE, as identified in the uplink data that accompanied the SRS, are not to be used for receiving and/or transmitting (e.g., any signal, particular signals such as those associated with user data, etc.) and/or that one or more particular antennas are specifically to be used for receiving and/or transmitting. Alternatively or additionally, the base station may determine (e.g., based on channel quality determinations) that one or more particular antennas at the UE, as identified in the uplink data that accompanied the SRS, are to be adjusted or configured in a particular manner (e.g., adjust power, adjust directionality, etc.).

Further at 210, the base station may generate the instructions to be sent to the UE. Such instructions may include data or other information explicitly identifying one or more antennas using an antenna identifier (e.g., based on a received antenna symbol and/or other antenna identification data received from the UE). In examples, these instructions may include instructions related to the antenna configuration or adjustment, such as instructions to implement the antenna configuration for a particular period of time and/or under particular conditions. Further instruction content may include instructions to implement the indicated antenna configuration changes at a particular time. Other instruction content may include instructions to adjust a period of transmission of a reference signal (e.g., SRS) and antenna identifiers. Any other instructions associated with antenna configuration adjustments and/or the results of channel quality and/or characteristics determination operations may also be generated at 210.

In examples, the instructions generated for transmission to the UE may also, or instead, include instructions directing the UE to release, from use with SRS beamforming, the resources (e.g., antenna(s) and/or antenna port(s)) associated with the SRS-based low quality channel determinations. Such instruction may further direct the UE to reconfigure such resources for use with (e.g., only) channel state information reference signal (CSI-RS), for instance, for codebook type 1 and/or type 2 beamforming techniques.

At 212, the base station may transmit the generated instructions to the UE. In some examples, the UE may implement the instructed adjustments upon receipt, while in other examples, the UE may implement instructed adjustments at particular times configured at the UE and/or at a time indicated by the base station.

At 214, the base station may determine whether to adjust any base station configuration based on the channel quality and/or characteristics determination operations at 206. For example, the base station may determine that a particular channel has a transmit power level that is below a minimum acceptable power level threshold. In response, at 214, the base station may determine that one or more operations are to be performed to adjust transmission and/or reception at the base station for interactions with the UE using the antenna associated with that channel. Alternatively or additionally, the base station may, by default, determine local configurations for exchanging signals with the antennas at the UE regardless of the results of the channel quality and/or characteristics determination operations at 206.

If, at 214, the base station determines that no base station configuration adjustments are needed or to be implemented based on the channel quality and/or characteristics determination operations performed at 206, the process 200 may return to 202 to receive subsequent SRS and antenna information from the UE.

If, at 214, the base station determines that base station configuration adjustments are needed or otherwise should be implemented, at 216, the base station may determine the particular local configuration changes to implement. For example, the base station may determine to not transmit signals (e.g., any signal, particular signals such as those associated with user data, etc.) to particular antennas configured at the UE that are determined to be performing poorly (e.g., not to transmit to the UE using the channels associated with such antennas). Alternatively or additionally, the base station may determine to increase the power used to transmit signals (e.g., any signal, particular signals such as those associated with user data, etc.) to particular antennas configured at the UE that are determined to be performing poorly (e.g., increase transmission power for transmitting over the channels associated with such antennas). Any other such configurations may be adjusted at the base station based on the channel quality and/or characteristics determination operations at 206.

At 218, the base station may implement the configurations determined at 216. The process 200 may return to 202 to receive subsequent SRS and antenna information from the UE.

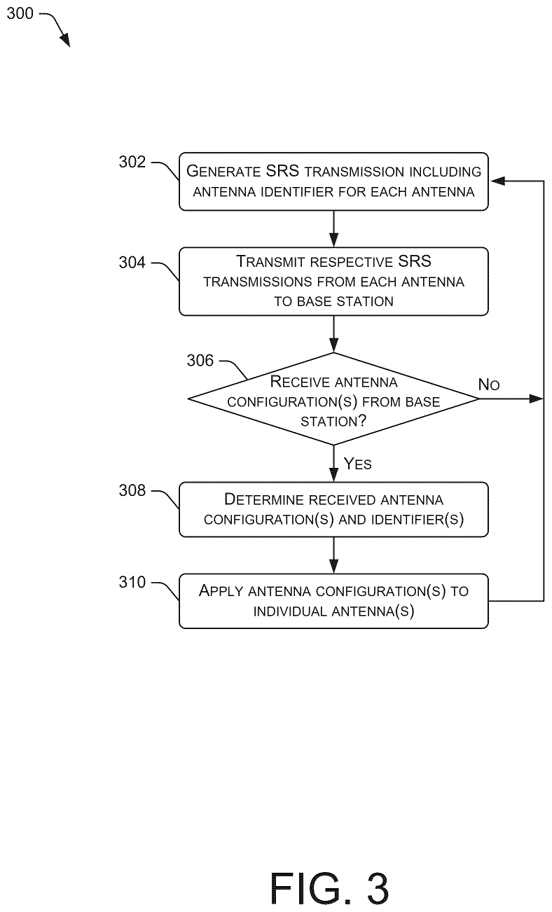

FIG. 3 shows a flow diagram of an illustrative process 300 for transmitting antenna identifiers and performing UE antenna configuration adjustments at a UE according to the disclosed embodiments. The process 300 is illustrated as a collection of blocks in a logical flow diagram, which represents a sequence of operations that can be implemented in software and executed in hardware. In the context of software, the blocks represent computer-executable instructions that, when executed by one or more processors, perform the recited operations. Generally, computer-executable instructions include routines, programs, objects, components, data structures, and the like that perform functions and/or implement particular abstract data types. The order in which the operations are described is not intended to be construed as a limitation, and any number of the described blocks can be omitted and/or combined in any order and/or in parallel to implement the processes. For discussion purposes, the process 300 may be described with reference to the wireless network environment 100 of FIG. 1, however other environments may also be used.

At block 302, a UE (e.g., UE 130) may generate a reference signal transmission, such as an SRS transmission (e.g., 4G SRS transmission, 5G SRS transmission, 6G SRS transmission, etc.) for an individual antenna configured at the UE (e.g., for a channel on which that antenna is operating). Along with the SR transmission, the UE may generate an antenna identifier. In examples, the UE may generate an antenna symbol indicating the antenna identifier and a reference signal symbol indicating the SRS value. The UE may configure these symbols temporally proximate to one another symbol (e.g., immediately preceding or following each other) in a slot of a frame or subframe to be transmitted to the UE on the channel associated with the corresponding antenna. Alternatively or additionally, the UE may use a portion of a single symbol to represent the SRS value and another portion of the same symbol to represent the antenna identifier. Alternatively or additionally, the UE may perform one or more operations using the antenna identifier and the SRS value to generate a symbol or a portion of a symbol representing a combination of the antenna identifier and a reference signal. Other means may also, or instead, be used at 302 to generate a reference signal and antenna identifier. The UE may perform the operations at 302 for each active antenna or antenna port configured at the UE, generating distinct reference signals and antenna identifiers for each such antenna or antenna port.

At 304, the UE may transmit the generated reference signals and antenna identifiers (e.g., the transmissions representing the distinct reference signals and antenna identifiers) to a base station (e.g., base station 120). For example, each antenna configured at the UE may individually transmit a reference signal and an antenna identifier associated with the transmitting antenna. As noted, the UE may transmit such reference signals and antenna identifiers as UCI or other control information.

At 306, the UE may determine or detect antenna configuration instructions received from the base station. For example, the base station may generate antenna configuration instructions for the UE based at least on individual reference signals and antenna identifiers transmitted by individual antennas configured at the UE. If no such instructions are received (e.g., before the next SRS transmission period), the process 300 may return to 302 to generate and transmit the next SRS and antenna identifier transmission.

At 306, if antenna configuration instructions are received from the base station, at 308, the UE may determine the configurations and the applicable antenna(s) based on the instructions. For example, the instructions may specify, using one or more antenna identifiers, one or more particular antennas of the UE that are not to be used for receiving and/or transmitting (e.g., any signal, particular signals such as those associated with user data, etc.) and/or that one or more particular antennas of the UE are specifically to be used for receiving and/or transmitting. Alternatively or additionally, the instructions may specify, using one or more antenna identifiers, that one or more particular antennas of the UE are to be adjusted or configured in a particular manner (e.g., increase/decrease power, activate/deactivate, adjust directionality, etc.). In further examples, the instructions may specify, using one or more antenna identifiers, that particular antenna configurations are to be implemented at a specific time, for a specified time period or duration, etc. The instructions may also, or instead, instruct the UE to adjust a reference signal transmission period (e.g., for one or more channels associated with one or more particular respective antennas indicated by one or more antenna identifiers included with such instructions). Any other configurations and/or operations associated with antenna configuration adjustments and/or particular identified antennas may also be determined at 308 based on instructions received from the base station.

At 310, the determined configurations and/or operations may be implemented or otherwise executed at the UE. The process 300 may return to 302 to generate and transmit the next SRS and antenna identifier transmission.

In summary, by providing explicit identification of antennas to a base station so that the base station can generate antenna-specific instructions for UEs, the disclosed systems and techniques may be able to increase the efficiency of usage of UE resources, particularly antennas, and network resources, improving the user experience and performance of both the network and user devices.

### Illustrative Signal Quality Representations

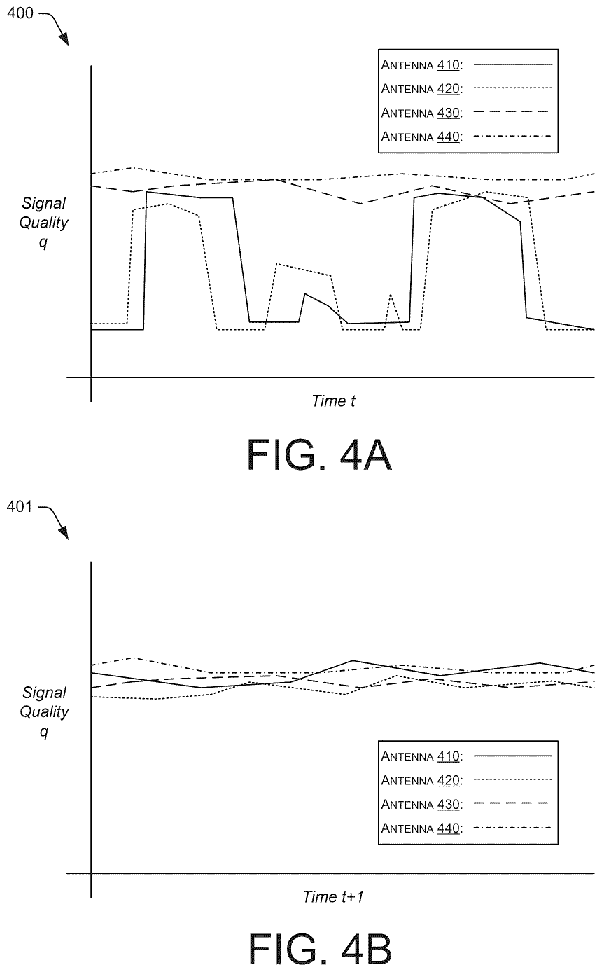

FIG. 4A shows a diagram 400 representing illustrative signal quality representations. In 400, the signal qualities determined for individual antennas by a base station based on SRS or other reference signals received from a UE are represented over a time period t. As shown here, a signal quality measurement q is illustrated for each of antennas 410, 420, 430, and 440 over the time period t. The signal quality represented in diagram 400 may be a transmit power for each of these antennas determined by the base station using the SRS received in transmissions from such antennas (e.g., over a channel on which the respective antenna operates). In other examples, the signal quality determined by a base station may be based on other criteria and/or measurements, such as noise, an SNR, etc.

As can be seen in this figure, the antennas 410 and 420 have widely varying signal quality over time, with relatively low signal quality q for significant portions of the time period t. On the other hand, the antennas 430 and 440 have relatively stable and high signal quality q over the time period t. Based on these determined signal quality measurements, the base station may determine to generate and transmit instructions to the base station to adjust the confirmation of the antennas 410 and 420.

For example, the base station may generate instructions directing the UE device not to use the antennas 410 and 420, either generally or for transmission and/or reception of particular signal types (e.g., user data-related signal transmission and/or reception). These instructions may explicitly identify the antennas 410 and 420. The base station itself may also, or instead, determine not to transmit signals to the UE on channels associated with those two antennas.

The base station may also, or instead, generate instructions directing the UE to use (e.g., only) the antennas 430 and 440 for receiving signals from the base station and/or transmitting signals to the base station, here again, either generally or for transmission and/or reception of particular signal types (e.g., user data-related signal transmission and/or reception). These instructions may explicitly identify the antennas 430 and 440. The base station itself may also, or instead, determine only to transmit signals to the UE on channels associated with those two antennas.

The base station may also, or instead, generate instructions directing the UE to adjust the configuration of one or more of the antennas 410, 420, 430, and 440. For example, the base station may generate instructions directing the UE to increase power at the antennas 410 and 420 to improve the ability of those antennas to receive signals from the base station. These instructions may explicitly identify the antennas 410 and 420. Alternatively or additionally, the base station may generate instructions directing the UE to adjust the directionality of the antennas 410 and 420 (e.g., using beamforming techniques) to improve reception capabilities of those antennas. Any such instructions may explicitly identify the antennas 410 and 420.

As a result of these adjustments implemented at the UE based on instructions received from the base station, the signal quality determined at the base stations may change.

FIG. 4B shows a diagram 401 representing illustrative signal quality representations following UE adjustments based on base station antenna configuration instructions. In 401, the signal qualities determined for individual antennas by a base station based on SRS or other reference signals received from a UE are represented over a time period t+1 that may be subsequent to the time period t of FIG. 4A. As shown here, a signal quality measurement q illustrated for each of the antennas 410, 420, 430, and 440 over the time period t+1 may differ for at least some of the antennas. This may be due to the base station sending instructions to the UE (e.g., after time period t and/or before time period t+1) to adjust one or more of the antennas 410, 420, 430, and 440 based on the signal qualities determined as illustrated in FIG. 4A.

For example, the base station may have instructed the UE to increase the power and/or the directionality of antennas 410 and 420. This may result in the determined signal qualities for these antennas shown in 401, where all the antennas exhibit a roughly similar and consistent signal quality.

### Illustrative Data Structures

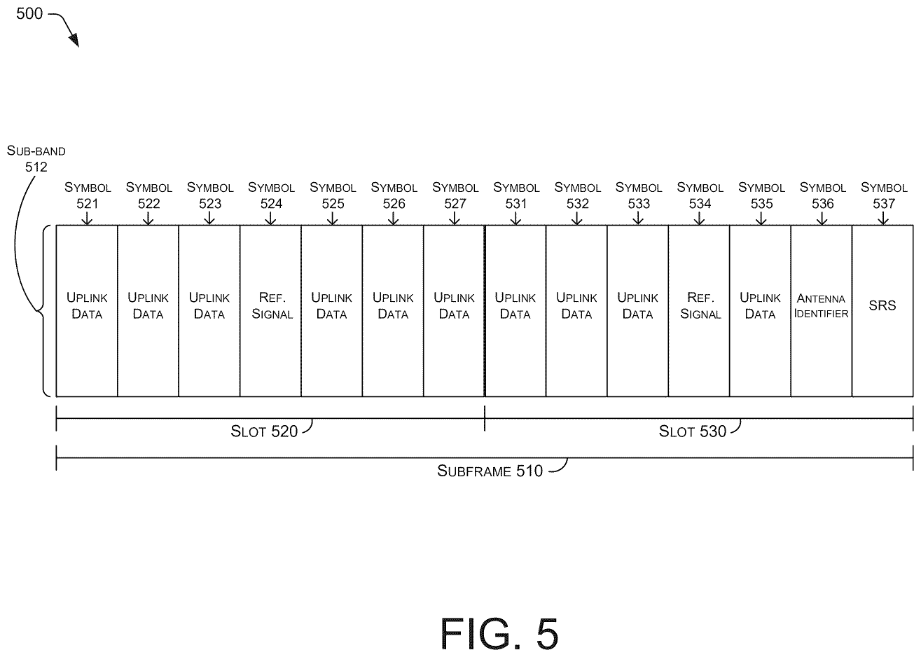

FIG. 5 shows a block diagram representing an illustrative data structure 500. The data structure 500 may include a subframe 510 of a transmission on a particular channel at a frequency sub-band 512 and transmitted by a particular antenna. In examples, the data structure 500 may be transmitted as a 4G transmission, a 5G transmission, or a 6G transmission. The sub-band 512 may be a portion of a frequency band assigned to the UE transmitting the data structure 500. The UE may transmit signals in other portions of the frequency band using other antennas.

The subframe 510 may include slots 520 and 530. The slot 520 may include symbols 521-527. The slot 530 may include symbols 531-537. Several of the symbols in each slot 520 and slot 530 may include uplink data. In some examples, each of the slots 520 and 530 may also include a reference signal (e.g., at symbols 524 and 534, respectively). These reference signals may be references signals used for various purposes that may be distinct from the usage of the SRS as described herein (e.g., demodulation reference signal (DMRS), phase tracking reference signal (PTRS), channel state information reference signal (CSI-RS), other types of uplink reference signals, etc.).

In examples, the UE transmitting on the sub-band 512 using a particular antenna may transmit an SRS value in the symbol 537. This SRS value may be used by a base station as described herein to determine channel quality and/or characteristics for the channel and/or the antenna associated with the sub-band 512. The UE may also transmit an antenna identifier value in the symbol 536. As described herein, a base station may use this antenna identifier value to generate instructions that direct the UE to implement antenna-specific configurations.

### Example User Equipment

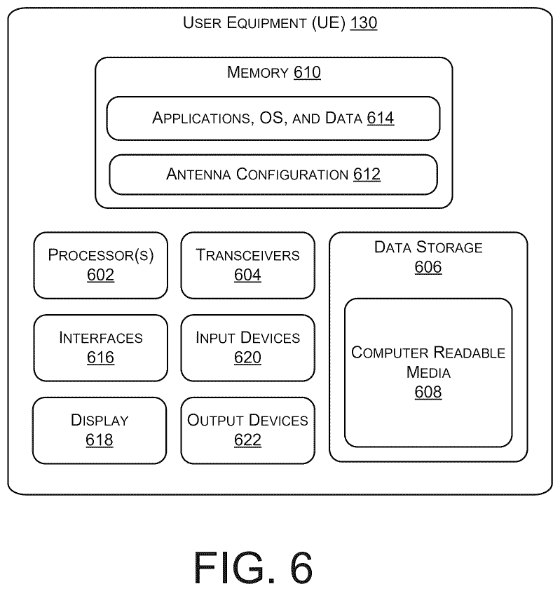

FIG. 6 is an example of a UE, such as UE 130, for use with the systems and methods disclosed herein, in accordance with some examples of the present disclosure. The UE 130 may include one or more processors 602, one or more transmit/receive antennas (e.g., transceivers or transceiver antennas) 604, and a data storage 606. The data storage 606 may include a computer-readable media 608 in the form of memory and/or cache. This computer-readable media may include a non-transitory computer-readable media. The processor(s) 602 may be configured to execute instructions, which can be stored in the computer-readable media 608 and/or in other computer-readable media accessible to the processor(s) 602. In some configurations, the processor(s) 602 is a Central Processing Unit (CPU), a Graphics Processing Unit (GPU), or both CPU and GPU, or any other sort of processing unit. The transceiver antenna(s) 604 can exchange signals with a base station, such as base station 120.

The UE 130 may be configured with a memory 610. The memory 610 may be implemented within, or separate from, the data storage 606 and/or the computer-readable media 608. The memory 610 may include any available physical media accessible by a computing device to implement the instructions stored thereon. For example, the memory 610 may include, but is not limited to, RAM, ROM, EEPROM, a SIM card, flash memory or other memory technology, CD-ROM, DVD or other optical disk storage, magnetic cassettes, magnetic tape, magnetic disk storage or other magnetic storage devices, or any other medium which may be used to store the desired information and which may be accessed by the UE 130.

The memory 610 can store several modules, such as instructions, data stores, and so forth that are configured to execute on the processor(s) 602. In configurations, the memory 610 may also store one or more applications 614 configured to receive and/or provide voice, data, and messages (e.g., SMS messages, Multi-Media Message Service (MMS) messages, Instant Messaging (IM) messages, Enhanced Message Service (EMS) messages, one or more dialers and related components, etc.) to and/or from another device or component (e.g., the base station 120). The applications 614 may also include one or more operating systems and/or one or more third-party applications that provide additional functionality to the UE 130. The applications 614 may also include antenna-related components, such as the antenna configuration component 612 that may be configured to perform any of the antenna-related operations described herein. The memory may also, or instead, store bandwidth information, such as UE-supported bands, bandwidth(s), and bandwidth parts, one or more IP addresses, indications of sets of IP addresses, as well as communications session information such as UE-specific carrier bandwidth(s). The memory may also, or instead, antenna configuration information, session management component information, user plane component information, policy component information, etc.

Although not all illustrated in FIG. 6, the UE 130 may also comprise various other components, e.g., a battery, a charging unit, one or more network interfaces 616, an audio interface, a display 618, a keypad or keyboard, and one or more input devices 620, and one or more output devices 622.

### Example Computing Device

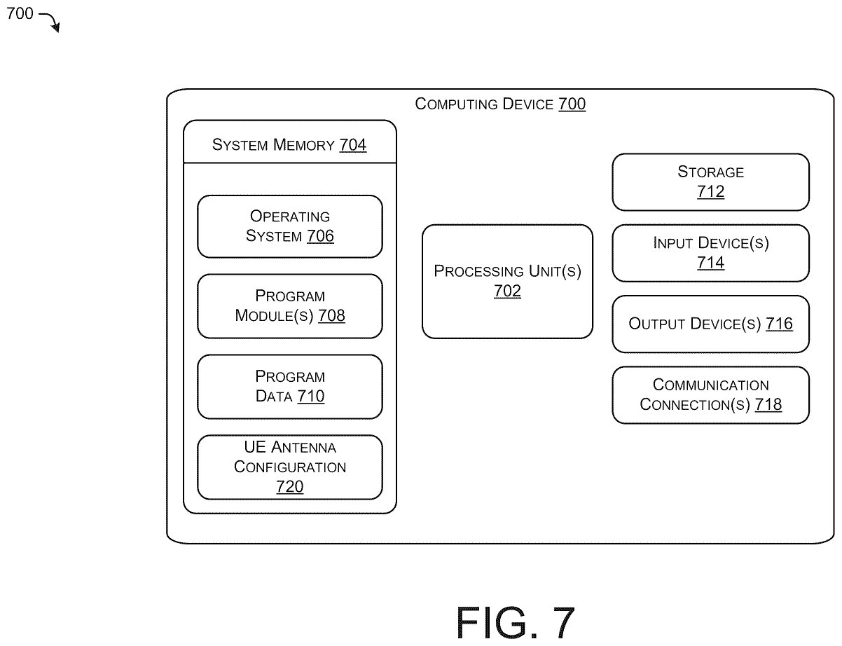

FIG. 7 is an example of a computing device 700 for use with the systems and methods disclosed herein, in accordance with some examples of the present disclosure. The computing device 700 can be used to implement various components of a core network, a base station (e.g., base station 120), and/or any servers, routers, gateways, gateway elements, administrative components, network components, etc. that can be used by a communication provider.

In various embodiments, the computing device 700 can include one or more processing units 702 and system memory 704. Depending on the exact configuration and type of computing device, the system memory 704 can be volatile (such as RAM), non-volatile (such as ROM, flash memory, etc.) or some combination of the two. The system memory 704 can include an operating system 706, one or more program modules 708 (e.g., channel quality determination component(s) and/or module(s), UE configuration component(s) and/or module(s), base station configuration component(s) and/or module(s)), program data 710, and UE antenna configuration data 720. The system memory 704 may be secure storage or at least a portion of the system memory 704 can include secure storage. The secure storage can prevent unauthorized access to data stored in the secure storage. For example, data stored in the secure storage can be encrypted or accessed via a security key and/or password.

The computing device 700 can also include additional data storage devices (removable and/or non-removable) such as, for example, magnetic disks, optical disks, or tape. Such additional storage is illustrated in FIG. 7 by storage 712.

The computing device 700 may store, in either or both of the system memory 704 and the storage 712, antenna information, antenna configuration information, UE information, location information, IP addresses, IP address data, timer information and/or timestamps, message transfer data, session management data, etc.

Non-transitory computer storage media of the computing device 700 can include volatile and nonvolatile, removable and non-removable media implemented in any method or technology for storage of information, such as computer-readable instructions, data structures, program modules, or other data. The system memory 704 and storage 712 are examples of computer-readable storage media. Non-transitory computer-readable storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by computing device 700. Any such non-transitory computer-readable storage media can be part of the computing device 700.

In various embodiments, any or all of the system memory 704 and storage 712 can store programming instructions which, when executed, implement some or all of the functionality described above as being implemented by one or more systems configured in the environment 100 and/or components of the network 110.

The computing device 700 can also have one or more input devices 714 such as a keyboard, a mouse, a touch-sensitive display, voice input device, etc. The computing device 700 can also have one or more output devices 716 such as a display, speakers, a printer, etc. can also be included. The computing device 700 can also contain one or more communication connections 718 that allow the device to communicate with other computing devices using wired and/or wireless communications.

### Example Clauses

The following paragraphs describe various examples. Any of the examples in this section may be used with any other of the examples in this section and/or any of the other examples or embodiments described herein.

A: A method performed by a wireless base station, the method comprising: receiving, from a mobile device on a first wireless communications channel, a first subframe comprising a first symbol representing a first sounding reference signal and a second symbol representing a first mobile device antenna identifier; determining a first channel characteristic for the first wireless communications channel based at least in part on the first sounding reference signal; determining a first mobile device antenna configuration based at least in part on the first channel characteristic; generating a first instruction for the mobile device comprising the first mobile device antenna configuration and the first mobile device antenna identifier; and transmitting the first instruction to the mobile device.

B: The method of paragraph A, further comprising: receiving, from the mobile device on a second wireless communications channel, contemporaneously with receiving the first subframe, a second subframe comprising a third symbol representing a second sounding reference signal and a fourth symbol representing a second mobile device antenna identifier; determining a second channel characteristic for the second wireless communications channel based at least in part on the second sounding reference signal; determining a second mobile device antenna configuration based at least in part on the second channel characteristic; generating a second instruction for the mobile device comprising the second mobile device antenna configuration and the second mobile device antenna identifier; and transmitting the second instruction to the mobile device.

C: The method of paragraph A or B, wherein the first mobile device antenna configuration causes the mobile device to increase transmission power at a first mobile device antenna associated with the first mobile device antenna identifier.

D: The method of any of paragraphs A-C, wherein the first mobile device antenna configuration causes the mobile device to exclude, from processing, transmissions received at a first mobile device antenna associated with the first mobile device antenna identifier.

E: The method of any of paragraphs A-D, wherein the first subframe is one of a 4G subframe or a 5G subframe.

F: The method of any of paragraphs A-E, further comprising modifying, based at least in part on the first channel characteristic, a configuration at the wireless base station associated with a first mobile device antenna associated with the first mobile device antenna identifier.

G: The method of any of paragraphs A-F, wherein the first instruction comprises at least one of a time of implementation of the first mobile device antenna configuration or a duration of the first mobile device antenna configuration.

H: A wireless communications device, comprising: one or more processors; a plurality of antennas; and non-transitory computer-readable media storing computer-executable instructions that, when executed by the one or more processors, cause the one or more processors to perform operations comprising: determining a first sounding reference signal for a first antenna of the plurality of antennas; determining a first antenna identifier for the first antenna; generating a first subframe comprising a first symbol representing the first sounding reference signal and a second symbol representing the first antenna identifier; transmitting the first subframe to a wireless base station; receiving a first instruction from the wireless base station comprising a first antenna configuration and the first antenna identifier, the first instruction being generated based at least on the first subframe; and configuring the first antenna based at least in part on the first antenna configuration and the first antenna identifier.

I: The wireless communications device of paragraph H, wherein the first subframe is one of a 4G subframe or a 5G subframe.

J: The wireless communications device of paragraph H or I, wherein the operations further comprise: determining a second sounding reference signal for a second antenna of the plurality of antennas; determining a second antenna identifier for the second antenna; generating a second subframe comprising a third symbol representing the second sounding reference signal and a fourth symbol representing the second antenna identifier; transmitting the second subframe to the wireless base station contemporaneously with transmitting the first subframe; receiving a second instruction from the wireless base station comprising a second antenna configuration and the second antenna identifier; and configuring the second antenna based at least in part on the second antenna configuration and the second antenna identifier.

K: The wireless communications device of any of paragraphs H-J, wherein configuring the first antenna comprises adjusting power provided to the first antenna.

L: The wireless communications device of any of paragraphs H-K, wherein configuring the first antenna comprises adjusting processing of signals received at the first antenna.

M: The wireless communications device of any of paragraphs H-L, wherein configuring the first antenna comprises configuring the first antenna based on the first antenna configuration at a time indicated in the first instruction.

N: The wireless communications device of any of paragraphs H-M, wherein configuring the first antenna comprises configuring the first antenna based on the first antenna configuration for a time period indicated in the first instruction.

O: A non-transitory computer-readable media storing computer-executable instructions that, when executed by one or more processors, cause the one or more processors to perform operations comprising: receiving, at a wireless base station, from a mobile device, and on a first wireless communications channel, a first subframe comprising a first symbol representing a first sounding reference signal and a second symbol representing a first mobile device antenna identifier; determining, at the wireless base station, a first channel characteristic for the first wireless communications channel based at least in part on the first sounding reference signal; determining, at the wireless base station, a first mobile device antenna configuration based at least in part on the first channel characteristic; generating, at the wireless base station, a first instruction for the mobile device comprising the first mobile device antenna configuration and the first mobile device antenna identifier; and transmitting, from the wireless base station, the first instruction to the mobile device.

P: The non-transitory computer-readable media of paragraph O, wherein the first subframe is one of a 4G subframe or a 5G subframe.

Q: The non-transitory computer-readable media of paragraph O or P, wherein the operations further comprise modifying, based at least in part on the first channel characteristic, a configuration at the wireless base station associated with a first mobile device antenna associated with the first mobile device antenna identifier.

R: The non-transitory computer-readable media of any of paragraphs O-Q, wherein the first instruction comprises at least one of a time of implementation of the first mobile device antenna configuration or a duration of the first mobile device antenna configuration.

S: The non-transitory computer-readable media of any of paragraphs O-R, wherein the first mobile device antenna configuration causes the mobile device to increase transmission power at a first mobile device antenna associated with the first mobile device antenna identifier.

T: The non-transitory computer-readable media of any of paragraphs O-S, wherein the first mobile device antenna configuration causes the mobile device to exclude, from processing, transmissions received at a first mobile device antenna associated with the first mobile device antenna identifier.

While the example clauses described above are described with respect to one particular implementation, it should be understood that, in the context of this document, the content of the example clauses can also be implemented via a method, device, system, computer-readable medium, and/or another implementation. Additionally, any of the examples A-T can be implemented alone or in combination with any other one or more of the examples A-T.

### Conclusion

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), 6G, Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

Depending on the embodiment, certain operations, acts, events, or functions of any of the algorithms described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, components, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks, modules, and components described in connection with the embodiments disclosed herein can be implemented or performed by a machine, such as a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The elements of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements, and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Unless otherwise explicitly stated, articles such as “a” or “the” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes that come within the meaning and range of equivalency of the claims are to be embraced within their scope.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method performed by a wireless base station, the method comprising:
receiving, from a mobile device on a first wireless communications channel, a first subframe comprising a first symbol representing a first sounding reference signal and a second symbol representing a first mobile device antenna identifier;
determining a first channel characteristic for the first wireless communications channel based at least in part on the first sounding reference signal;
determining a first mobile device antenna configuration based at least in part on the first channel characteristic;
generating a first instruction for the mobile device comprising the first mobile device antenna configuration and the first mobile device antenna identifier; and
transmitting the first instruction to the mobile device.

2. The method of claim 1, further comprising:
receiving, from the mobile device on a second wireless communications channel, contemporaneously with receiving the first subframe, a second subframe comprising a third symbol representing a second sounding reference signal and a fourth symbol representing a second mobile device antenna identifier;
determining a second channel characteristic for the second wireless communications channel based at least in part on the second sounding reference signal;
determining a second mobile device antenna configuration based at least in part on the second channel characteristic;
generating a second instruction for the mobile device comprising the second mobile device antenna configuration and the second mobile device antenna identifier; and
transmitting the second instruction to the mobile device.

3. The method of claim 1, wherein the first mobile device antenna configuration causes the mobile device to increase transmission power at a first mobile device antenna associated with the first mobile device antenna identifier.

4. The method of claim 1, wherein the first mobile device antenna configuration causes the mobile device to exclude, from processing, transmissions received at a first mobile device antenna associated with the first mobile device antenna identifier.

5. The method of claim 1, wherein the first subframe is one of a 4G subframe or a 5G subframe.

6. The method of claim 1, further comprising modifying, based at least in part on the first channel characteristic, a configuration at the wireless base station associated with a first mobile device antenna associated with the first mobile device antenna identifier.

7. The method of claim 1, wherein the first instruction comprises at least one of a time of implementation of the first mobile device antenna configuration or a duration of the first mobile device antenna configuration.

8. A wireless communications device, comprising:
one or more processors;
a plurality of antennas; and
non-transitory computer-readable media storing computer-executable instructions that, when executed by the one or more processors, cause the one or more processors to perform operations comprising:
determining a first sounding reference signal for a first antenna of the plurality of antennas;
determining a first antenna identifier for the first antenna;
generating a first subframe comprising a first symbol representing the first sounding reference signal and a second symbol representing the first antenna identifier;
transmitting the first subframe to a wireless base station;
receiving a first instruction from the wireless base station comprising a first antenna configuration and the first antenna identifier, the first instruction being generated based at least on the first subframe; and
configuring the first antenna based at least in part on the first antenna configuration and the first antenna identifier.

9. The wireless communications device of claim 8, wherein the first subframe is one of a 4G subframe or a 5G subframe.

10. The wireless communications device of claim 8, wherein the operations further comprise:
determining a second sounding reference signal for a second antenna of the plurality of antennas;
determining a second antenna identifier for the second antenna;
generating a second subframe comprising a third symbol representing the second sounding reference signal and a fourth symbol representing the second antenna identifier;
transmitting the second subframe to the wireless base station contemporaneously with transmitting the first subframe;
receiving a second instruction from the wireless base station comprising a second antenna configuration and the second antenna identifier; and
configuring the second antenna based at least in part on the second antenna configuration and the second antenna identifier.

11. The wireless communications device of claim 8, wherein configuring the first antenna comprises adjusting power provided to the first antenna.

12. The wireless communications device of claim 8, wherein configuring the first antenna comprises adjusting processing of signals received at the first antenna.

13. The wireless communications device of claim 8, wherein configuring the first antenna comprises configuring the first antenna based on the first antenna configuration at a time indicated in the first instruction.

14. The wireless communications device of claim 8, wherein configuring the first antenna comprises configuring the first antenna based on the first antenna configuration for a time period indicated in the first instruction.

15. A non-transitory computer-readable media storing computer-executable instructions that, when executed by one or more processors, cause the one or more processors to perform operations comprising:
receiving, at a wireless base station, from a mobile device, and on a first wireless communications channel, a first subframe comprising a first symbol representing a first sounding reference signal and a second symbol representing a first mobile device antenna identifier;
determining, at the wireless base station, a first channel characteristic for the first wireless communications channel based at least in part on the first sounding reference signal;
determining, at the wireless base station, a first mobile device antenna configuration based at least in part on the first channel characteristic;
generating, at the wireless base station, a first instruction for the mobile device comprising the first mobile device antenna configuration and the first mobile device antenna identifier; and
transmitting, from the wireless base station, the first instruction to the mobile device.

16. The non-transitory computer-readable media of claim 15, wherein the first subframe is one of a 4G subframe or a 5G subframe.

17. The non-transitory computer-readable media of claim 15, wherein the operations further comprise modifying, based at least in part on the first channel characteristic, a configuration at the wireless base station associated with a first mobile device antenna associated with the first mobile device antenna identifier.

18. The non-transitory computer-readable media of claim 15, wherein the first instruction comprises at least one of a time of implementation of the first mobile device antenna configuration or a duration of the first mobile device antenna configuration.

19. The non-transitory computer-readable media of claim 15, wherein the first mobile device antenna configuration causes the mobile device to increase transmission power at a first mobile device antenna associated with the first mobile device antenna identifier.

20. The non-transitory computer-readable media of claim 15, wherein the first mobile device antenna configuration causes the mobile device to exclude, from processing, transmissions received at a first mobile device antenna associated with the first mobile device antenna identifier.
